(19) United States
(12) Patent Application Publication
(10) Pub. No.: US 2026/0254389 A1
(43) Pub. Date: Aug. 27, 2026

(54) Drive and Load System for a Rotating Electric Machine, Test Stand, and Electric Load and Drive Train

(71) Applicant: Horiba Europe GmbH, Darmstadt (DE)

(72) Inventor: Herbert Sennhenn, Messel (DE)

(21) Appl. No.: 19/136,469

(22) PCT Filed: Nov. 29, 2023
(86) PCT No.: PCT/EP2023/083517

§ 371 Date: Jun. 6, 2025

(30) Foreign Application Priority Data
Dec. 7, 2022 (DE) 102022132523.7

(51) Int. Cl. H02P 27/06; B60L 15/00; G01M 13/025

(52) U.S. Cl. CPC H02P 27/06; B60L 15/007; G01M 13/025; B60L 2210/10

(57) ABSTRACT

The invention relates to a drive and load system for a rotating electric machine which has a controllable power source that can be connected to a power supply. The controllable power source is connected to an intermediate circuit that has a capacitor for temporarily storing power. The capacitor thus acts as an energy store in order to stabilise the intermediate circuit voltage. The drive and load system also has a motor inverter which is connected to the intermediate circuit and which converts the intermediate circuit voltage applied to the motor inverter input into a drive current for a rotating electric machine, or feeds a load current from the electric machine back into the intermediate circuit. A closed control loop of the drive and load system, the actual value input of which is connected to the motor inverter input, controls the motor inverter input voltage as an actual value to a setpoint U_{Set} in a closed-loop manner by means of the controllable power source. According to the invention, the drive and load system has a setpoint output device which is connected to the setpoint input of the closed control loop and sets its current setpoint U_{Set} (t). The setpoint output device is suitable for determining the setpoint U_{Set} (t) for the closed control loop by means of a predefined setpoint curve U_{Set} [n(t)] depending on the speed n(t) of the electric machine.

### TECHNICAL FIELD

The invention relates to a drive and load system for a rotating electric machine, which can be used in a test stand, in particular in a motor, gearbox, brake or vehicle test stand, in an electric load train, in particular for a current generator, or in an electric drive train, in particular for an electric vehicle.

### BACKGROUND

Modern test stands in the automotive sector cover the main areas of motor testing/gearbox testing/brake testing. They can be used in any type of development and functional test stands. The range of uses extends from simple stationary test stands to highly dynamic test stands with road load simulation (RLS) for driver or vehicle simulation. Statutory emission tests such as ELR, ESC and ETC are other typical applications.

These test stands use so-called dynamometers, which can drive and also load a test specimen such as an internal combustion engine or an electric motor of an electric vehicle. Furthermore, it is possible that at least one complete vehicle stands on running drums that are braked via a dynamometer. These dynamometers are therefore particularly high-torque drive and load machines that are composed of an electric alternating current motor and a motor inverter. The current supply, in this case, is provided by means of direct voltage, with the motor being controlled via a machine-side pulse inverter. The motor inverter thus supplies the electric motor with a predetermined voltage and a time-dependent current in order to provide arbitrary dynamics of the dynamometer in either drive or load mode. Such modern pulse inverters are equipped with IGBT (insulated gate bipolar transistor) switching elements to enable both motor and generator operation at full current. The use of SiC MOSFETs (metal oxide semiconductor field effect transistors) instead of IGBTs is also conceivable.

Although such IGBT or MOSFET-equipped pulse inverters enable highly dynamic control of the electric machine, this flexibility is accompanied by switching losses in the transistors used in the motor inverter. The switching losses in the IGBTs of the motor inverter depend, in this case, on the pulse frequency (high frequencies produce high losses), the current and the voltage applied to the intermediate circuit or DC bus (high voltages produce high losses). The temperature losses in a three-phase AC motor (asynchronous or synchronous) connected to a motor inverter depend on the harmonics of the current. These harmonics are strongly dependent on the pulse frequency (high frequencies produce low amplitudes, which, in turn, produce low losses) and the amount of the intermediate circuit voltage (DC bus voltage).

DE 10 2017 220 682 A1 is directed to a control device for rotating electric alternating current machines. In this case, an electric direct current machine is controlled in a closed-loop manner on the basis of a midpoint potential in order to reduce the load on the controlling central processor unit.

A motor control device and a control method in which the motor is controlled by comparing the phase voltage value with the pulse width modulation count value are known from DE 10 2019 114 480 A1. This motor control reduces errors in the switching process and improves the accuracy of the control.

EP 3 809 584 A1 is directed to a motor control device. In this case, a motor stop signal is delayed based on the time required to convert the leakage current into an analog signal by the current detector. Incorrect detection of the leakage current caused by switching the power conversion element on and off can therefore be reduced.

However, the known motor inverter systems all have the problem that unnecessary losses occur in the drive system and the alternating current machine at low speeds of the alternating current machine.

### SUMMARY

The invention is therefore based on the object of producing a drive and load system for a rotating electric machine in which the magnetic losses in the electric machine, as well as the switching losses in a motor inverter of the drive and load system are reduced.

This object is achieved by the drive and load system, by the test stand, by the load train, and by the drive train described herein. Advantageous embodiments and further developments of the invention are described herein.

In accordance with the invention, a drive and load system for a rotating electric machine is produced which has a controllable current source that can be connected to a current supply. The controllable current source is connected to an intermediate circuit that has a capacitor for the intermediate storage of current. The capacitor therefore acts as an energy storage for stabilizing the intermediate circuit voltage. The drive and load system further includes a motor inverter connected to the intermediate circuit, which converts the intermediate circuit voltage applied to the motor inverter input into a drive current for a rotating electric machine or feeds a load current from the electric machine back into the intermediate circuit. A closed-loop control circuit of the drive and load system, the actual value input of which is connected to the motor inverter input, controls the motor inverter input voltage as an actual value to a setpoint U_{Set} in a closed-loop manner by means of the controllable current source. In accordance with the invention, the drive and load system includes a setpoint output device which is connected to the setpoint input of the closed-loop control circuit and sets its current setpoint U_{Set} (t). The setpoint output device is suitable for determining the setpoint U_{Set} (t) for the closed-loop control circuit as a function of the speed n(t) of the electric machine by means of a predetermined setpoint curve U_{Set} [n(t)].

In accordance with the invention, a frequency converter system or a motor inverter system is thus provided for an electric alternating current machine, in which the alternating current machine is preferably controlled by a pulse inverter which has switching elements that are used in the inverter process. Instead of a constant supply voltage being applied to the motor inverter input, the input voltage on the motor inverter is set as a function of the speed of the alternating current machine, with lower voltages preferably being applied to the motor inverter input at lower speeds. Switching losses in the switching elements of the motor inverter and/or magnetic losses within the alternating current machine can therefore be reduced.

Since the switching losses are high at high voltages, whereas the switching losses can be reduced by reducing the input voltage on the motor inverter accordingly, and at the same time the voltage requirement of the electric machine or the E-motor increases with increasing speed, it is advantageous if the setpoint curve U_{Set} [n(t)] is increased in steps or gradually as the speed n increases.

As the required supply voltage of the motor inverter and the electric machine runs into saturation from a specific speed, it is advantageous if the setpoint curve U_{Set} [n(t)] has a constant saturation value U_{Max} from a saturation speed n_{Sat}.

As a minimum supply voltage value must be applied to the motor inverter input at low speeds, it is expedient if the setpoint curve U_{Set} [n(t)] has a constant offset value U_{offset} as an addend.

In order for a specific power buffer or supply voltage buffer to be available at the motor inverter input in case of large speed changes, it is advantageous if the setpoint curve U_{Set} [n(t)] has a positive lead component b*dn/dt as the addend, which is equal to 0 in case of speed changes dn/dt<0.

In order to simulate the setpoint curve as accurately as possible to an actually required supply voltage at the motor inverter input, where a corresponding safety margin or voltage buffer is added, it is expedient if the setpoint curve U_{Set} [n(t)] is divided into N consecutive speed intervals I₁ to I_{N} and runs in the xth speed interval Iₓ with an associated linear gradient ax, wherein aₓ>aₓ₊₁>0 applies to the gradients.

In this case, for a very precise adjustment or fitting of the setpoint curve to the required supply voltage as a function of the speed n, it is particularly advantageous if the following applies to the setpoint curve U_{Set} [n(t)] in the xth speed interval Iₓ of N consecutive speed intervals I₁ to I_{N}: U_{Set_x} [n(t)]=aₓ*n(t)+bx*dn/dt+U_{Offset}+U_{Delta_x}, for nₓ₋₁≤n≤nₓ, wherein n₀=0; aₓ is a gradient factor with a₀=0 and aₓ>0; dn/dt is the time derivative of the speed n(t), bx is a lead factor with bₓ=0 at dn/dt<0, U_{offset} is an offset value, U_{Delta_x} is a continuity value with

$${U}_{Delta \_ x} = {\sum }_{i = 1}^{x} {a}_{i - 1} ( {n}_{i} - {n}_{i - 1} ) ,$$

and wherein the following additionally applies: U_{Set_x} [n(t)]=U_{Max} for n(t)>n_{N}=n_{Sat}.

Furthermore, it is advantageous if the setpoint curve U_{Set} (n) comprises a sum formed from a required supply voltage curve U_{Zk_min} (n) of the motor inverter and of the electric machine, as well as an offset value U_{Offset}.

In case that a required supply voltage curve is measured as a function of the speed, it is advantageous if the required supply voltage curve U_{Zk_min} (n) is an interpolated function of data points from measured required supply voltages and associated speeds n.

In order to be able to take the torque M of the electric machine into account in addition to the speed n, it is advantageous if the setpoint output device is further suitable for determining a current setpoint U_{Set} (t) for the closed-loop control circuit as a function of the torque M(t) of the electric machine by means of a predetermined setpoint curve U_{Set} [M(t)].

For reliable and fast switching behavior with simultaneously high currents of the switching elements in the motor inverter, it is particularly advantageous if the motor inverter comprises a pulse inverter that is equipped with power semiconductor switching elements, in particular IGBTs or SiC MOSFETS.

In case of a high-voltage current supply for the drive and load system and generally for test stand applications, it is particularly expedient if the controllable current source for a 3-phase high-voltage current supply comprises a frequency converter with a controlled mains rectifier, in particular an active front-end (AFE) converter with PID closed-loop control.

In accordance with the invention, a test stand, in particular a motor, gearbox, brake or vehicle test stand, is further provided which includes the electric drive and load system according to the invention. In this case, the motor or gearbox test stand further has an electric machine connected to the motor inverter, which can be configured as an asynchronous machine or synchronous machine and is adapted to drive or load a test specimen designed as an electric motor or internal combustion engine. The test stand further includes a mechanical shaft connection which is adapted to connect the shafts of the electric machine and the test specimen. Furthermore, the motor or gearbox test stand has a torque measuring unit which is adapted to measure the torque M(t) via a torque measuring flange on the shaft connection and transmit it to an evaluation unit. The speed N (t) is measured via a pulse generator on the shaft connection by means of a speed recording unit of the motor or gearbox test stand and transmitted to the evaluation unit. The evaluation unit is adapted to receive the measured torque M(t) and the measured speed n(t) from the torque measuring unit and the speed recording unit and store them for further evaluation of the test procedure.

Furthermore, in accordance with the invention, an electric load train is provided, in particular for a current generator, which includes the drive and load system according to the invention. The electric load train, in this case, has an electric machine connected to the motor inverter output, which is configured as a current generator machine and sends a generated alternating current to the motor inverter and the controllable current source as a frequency converter in order to feed a frequency-converted current into a mains supply. Due to the adjustment of the output voltage applied to the motor inverter input to the speed of the current generator machine, particularly effective current generation can be achieved in electric power plants in which the generator speed is not or cannot be kept constant. Such a load train, for example, would be particularly advantageous for use in gearless wind turbines.

In addition, in accordance with the invention, an electric drive train, in particular for an electric vehicle, is provided, which includes the drive and load system according to the invention, with the current supply being a mobile current supply, in particular an accumulator module. This electric drive train further includes the electric machine connected to the motor inverter output, which converts the drive current into rotational power and feeds braking power back into the motor inverter, with the controllable current source being configured as a DC/DC converter. By adjusting the input voltage at the motor inverter input to the speed of the electric machine, the switching losses in the motor inverter and/or the magnetic losses in the alternating current machine can be reduced, which drastically reduces the current consumption of the electric vehicle and can therefore increase the range of the electric vehicle.

### BRIEF DESCRIPTION OF THE DRAWINGS

The invention will be described in detail in the following text, with reference to the drawings, in which:

FIG. 1A shows a schematic view of a motor or gearbox test stand according to an exemplary embodiment of the invention;

FIG. 1B shows a schematic block diagram of the motor or gearbox test stand according to an exemplary embodiment of the invention;

FIG. 2 shows a schematic block diagram of an electric drive and load train according to an exemplary embodiment of the invention;

FIG. 3 shows a schematic block diagram of an electric drive and load system according to an exemplary embodiment of the invention;

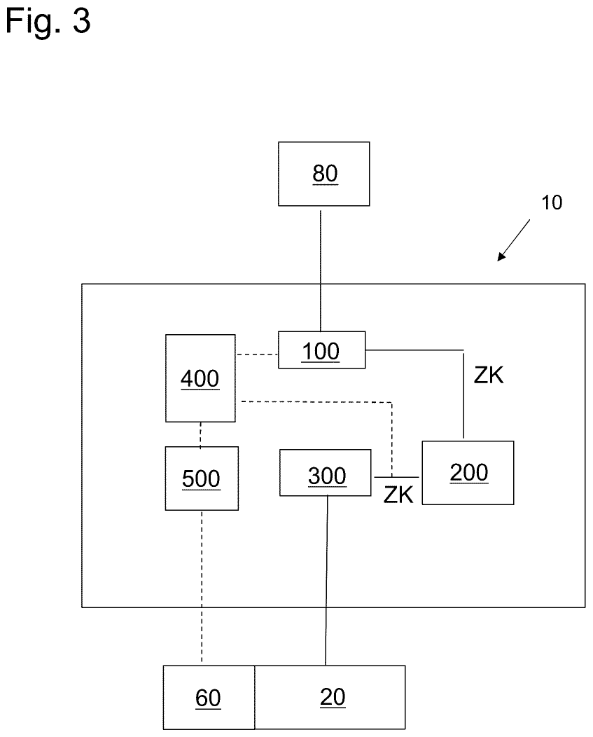

FIG. 4A shows a circuit configuration of a frequency converter with a controlled mains rectifier for controlling an alternating current machine according to the prior art;

FIG. 4B shows a schematic block diagram for illustrating the energy flow in a drive or load train according to the prior art;

FIG. 5A shows a schematic block diagram of an electric drive or load train according to the prior art;

FIG. 5B shows a U-n diagram of the required supply voltage of a motor inverter as a function of the speed and the fixed supply voltage applied to the motor inverter input according to the prior art;

FIG. 6A shows a schematic block diagram of a drive and load train according to an exemplary embodiment of the invention;

FIG. 6B shows a U-n diagram of the required supply voltage of a motor inverter as a function of the speed, as well as a setpoint curve as a function of the speed according to an exemplary embodiment of the invention; and

FIG. 7 shows a flow chart of a drive and load method according to an exemplary embodiment of the invention.

### DETAILED DESCRIPTION

In the various figures of the drawings, components corresponding to one another are provided with identical reference numerals.

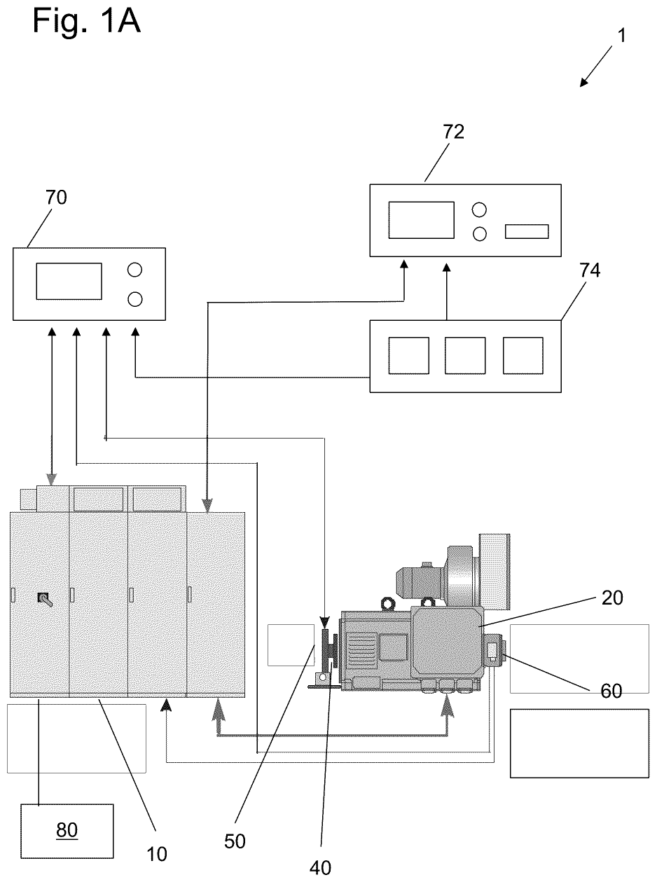

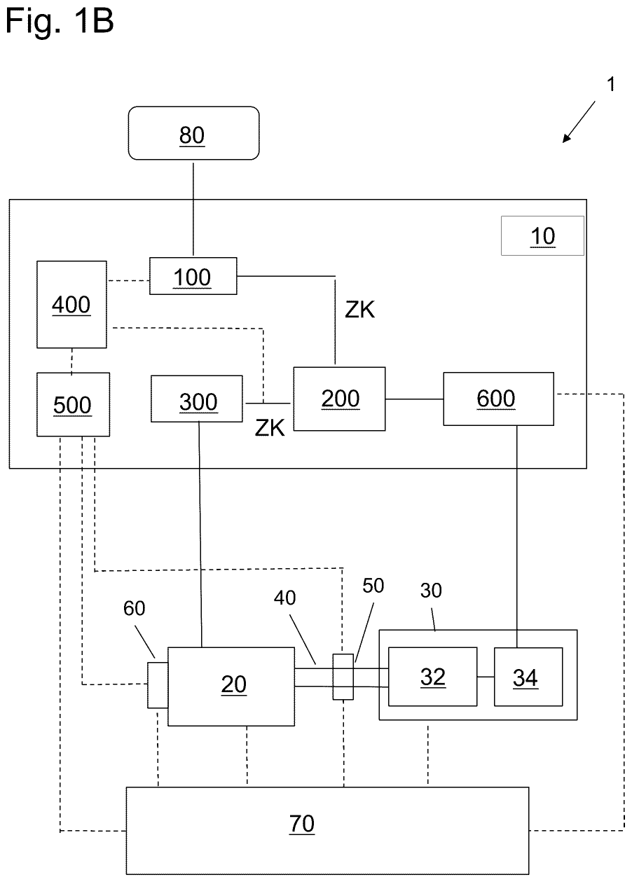

FIGS. 1A and 1B show schematic views of a motor or gearbox test stand 1 according to the invention. The motor or gearbox test stand 1 according to the invention has a drive and load system 10, which is connected to a current supply 80.

As can be seen in the schematic block diagram view of FIG. 1B, the drive and load system 10 according to the invention has a controllable current source 100 that can be connected to the current supply 80. The controllable current source 100 is connected to an intermediate circuit ZK, which has a capacitor 200 for the intermediate storage of current and/or as an energy storage for stabilizing the intermediate circuit voltage. The drive and load system 10 further includes a motor inverter 300 connected to the intermediate circuit, which converts the intermediate circuit voltage U_{Zk} applied to the motor inverter input into a drive current for the rotating electric machine 20 or feeds a load current from the electric machine 20 back into the intermediate circuit ZK. The drive and load system 10 comprises a closed-loop control circuit 400, the actual value input of which is connected to the motor inverter input, and which controls the motor inverter input voltage U_{Zk} as an actual value to a setpoint U_{Set} in a closed-loop manner by means of the controllable current source 100.

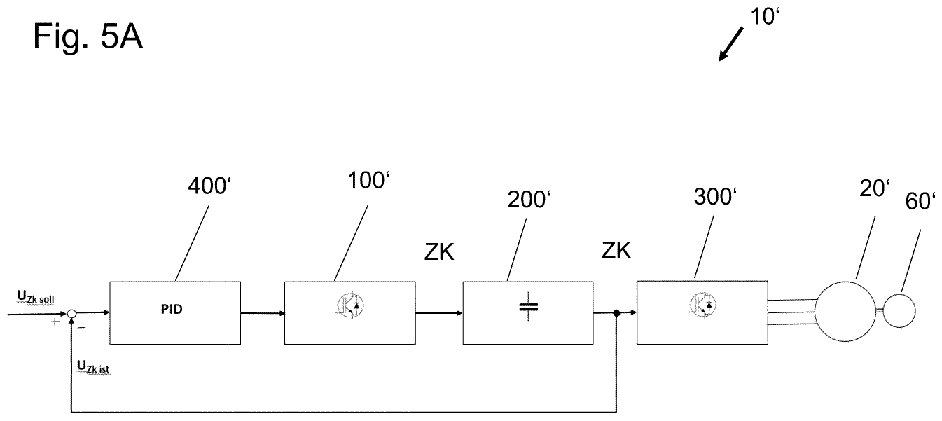

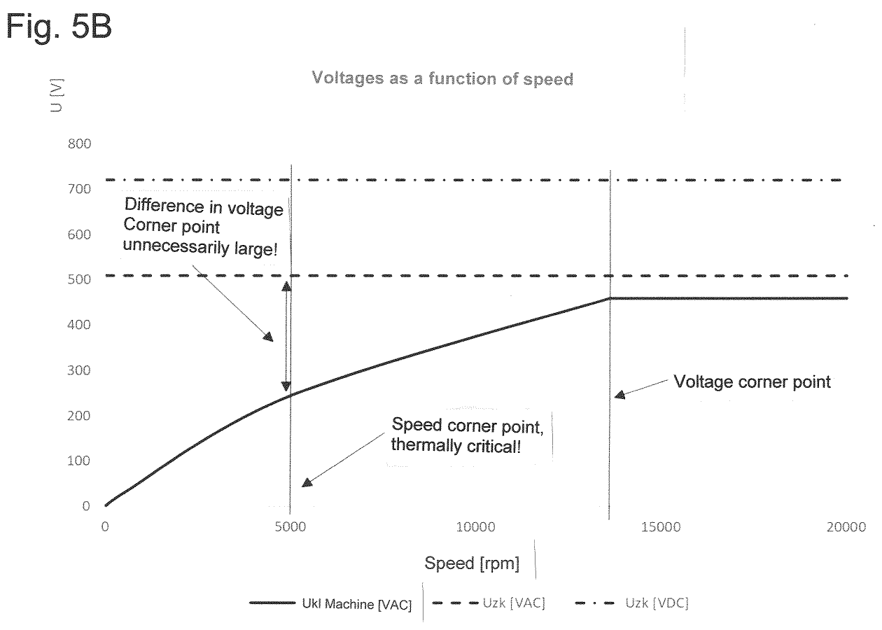

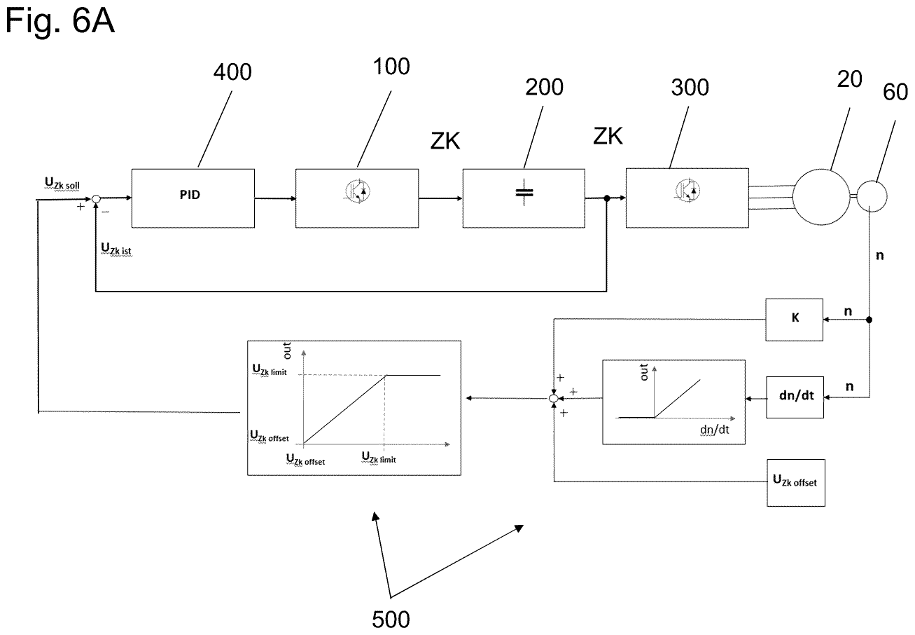

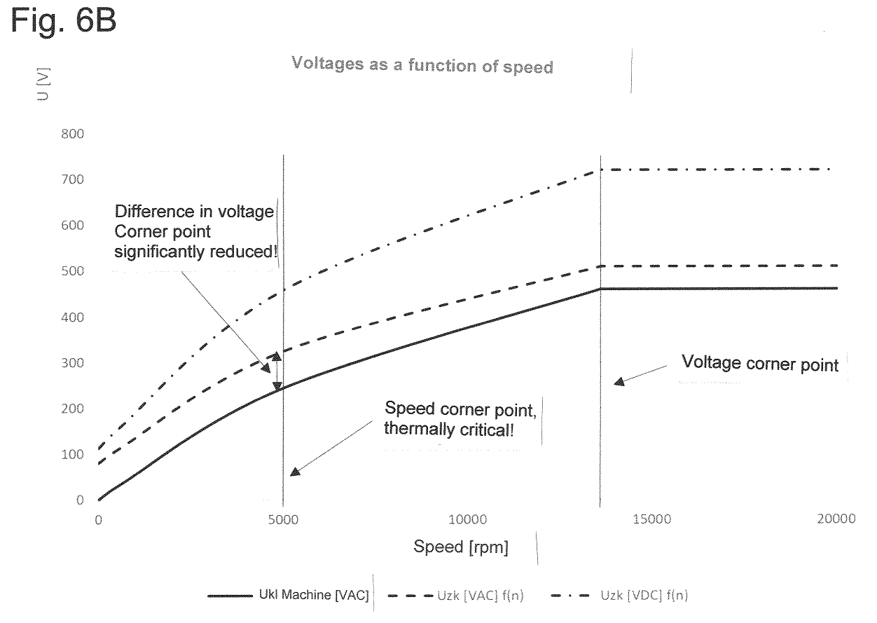

Furthermore, the drive and load system 10 includes a setpoint output device 500, which is connected to the setpoint input of the closed-loop control circuit 400 and sets its current setpoint U_{Set} (t). The setpoint output device 500 is suitable for determining the current setpoint U_{Set} (t) for the closed-loop control circuit 400 as a function of the speed n(t) of the electric machine 200 by means of a predetermined setpoint curve U_{Set} [n(t)]. The determination of the setpoint curve U_{Set} as a function of the speed n will be described in detail in the following text with reference to FIGS. 5C and 6B. In this case, the main purpose of setting the intermediate circuit voltage U_{Zk} at the motor inverter input is to reduce corresponding switching losses in the motor inverter 300 when controlling the electric machine 20, as well as magnetic losses in the alternating current machine 20.

As further shown in FIGS. 1A and 1B, the motor or gearbox test stand 1 includes the electric machine 20 connected to the motor inverter 300, which can be configured as an asynchronous machine or synchronous machine and is adapted to drive or load a test specimen 30 designed as an electric motor or internal combustion engine.

The asynchronous machine 20 is designed as a squirrel cage machine, which is characterized by a wide speed range, high dynamics and robustness. In the motor or gearbox test stand 1 according to the invention, the asynchronous machine 20 constitutes the drive and load device for the test specimen 30. The asynchronous machine 20 enables high speeds of up to 10,000 rpm and significantly higher and has low mass moments of inertia and overload capacity for high speed dynamics. The asynchronous machine 20 enables both generator and motor operation in two directions of rotation and can be coupled to high masses. In combination with the drive and load system 10, the machine 20 cannot only brake, but also drive, e.g., to simulate downhill travel and gear changes.

In case that the test specimen 30 is an electric motor, this electric motor 30 can include an alternating current machine 32 and a motor inverter 34. The motor inverter 34, in this case, is supplied with current by the drive and load system 10 in that the motor inverter 34 can be connected to the DC bus or intermediate circuit ZK. Here, a DC/DC converter 600 can optionally be interconnected to the intermediate circuit ZK and the capacitor 200 in order to level the voltage applied to the intermediate circuit ZK accordingly and set it to a desired input voltage on the motor inverter 34. However, it should be emphasized that the DC/DC converter 600 is an optional element of the electric drive and load system 10 according to the invention.

The shafts of the asynchronous machine 20 and the test specimen 30 are connected to one another via a mechanical shaft connection 40 in order to produce a torque connection between the two machines 20 and 30. The electric machine 20 is thus directly connected to the test specimen 30 via a measuring flange of a torque measuring unit 50 and the shaft connection 40. An intermediate bearing block is not required, as the electric machine 20 is designed for high couplable masses.

The torque measuring unit 50 is adapted to measure the torque M(t) via the torque measuring flange on the shaft connection 40 and transmit it to an evaluation unit 70. The torque measuring unit 50 is designed as a torque measuring flange with an integrated evaluation unit, which enables a dynamically correct measurement directly at the interface to the test specimen 30. The shaft torque between the asynchronous machine 20 and the test specimen 30 is recorded via a DMS measuring bridge on the rotating flange of the torque measuring unit 50 and transmitted to the stator without contact. The signal transmission from the rotor to the stator of the asynchronous machine 20 is digital. The feeding voltage transmission from the stationary to the rotating side is inductive. The measurement directly on the test specimen 30 guarantees a dynamically correct torque measurement. In addition to the torque measuring unit 50, a speed recording unit 60 is further provided, which is adapted to measure the speed n(t) via a pulse generator on the shaft connection 40 and transmit it to the evaluation unit 70. The speed recording by the speed recording unit 60 is carried out with a bearingless, encapsulated hollow shaft encoder, which is mounted on the side facing away from the test specimen 30. The scanning unit of the speed recording unit 60 is connected rigidly to the shaft 40, i.e., without a coupling. The speed sensor has two separate scanning systems for the drive and load system 10 and the evaluation unit 70 (see FIG. 1B), which enables redundant speed recording, which enables a safe shutdown in case of failure of one scanning system. The number of points/revolution is optimally matched to the respective speed range of the asynchronous machine 20.

The evaluation unit 70 is adapted to receive the measured torque M(t) and the measured speed n(t) from the torque measuring unit 50 and the speed recording unit 60 and store them for further evaluation of the test procedure. The evaluation unit 70, in this case, can be designed as a test stand controller, which functionally covers all areas of modern motor testing.

As shown in FIG. 1A, a safety center 72 can, in addition to the test stand controller 70, further be provided, which ensures a safe shutdown of the connected system/machine when an emergency stop is triggered. The safety center 72 records the input information from the connected devices and displays the status of the devices. The safety center 72 is a switching device that enables safe and redundant contact duplication of the emergency stop input signal. When an emergency stop command device is actuated, the safety contacts of the safety switching device open immediately and can therefore stop dangerous movements and switch off other hazards. In addition to the safety center 72, an optional feed module 74 can also be provided, which supplies the safety center 72 and the test stand controller 70 with current.

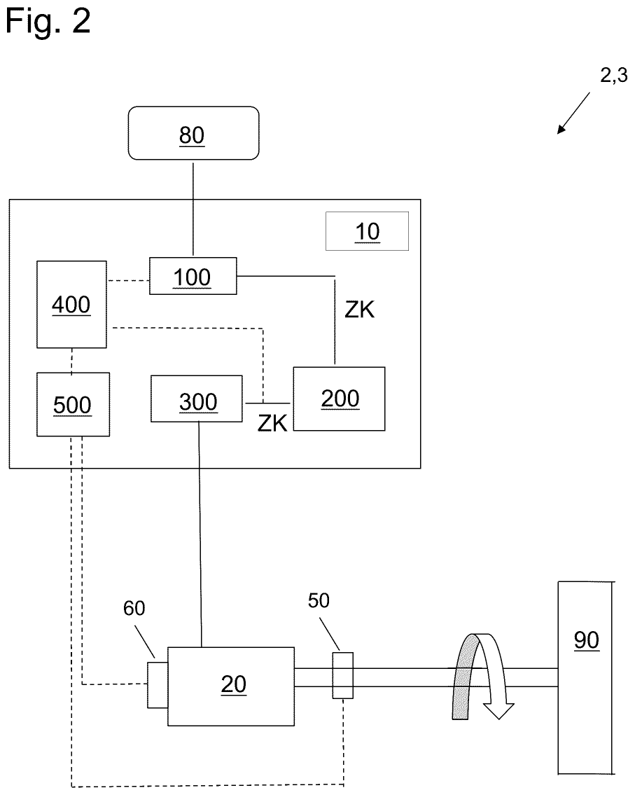

As shown in FIG. 2, the drive and load system 10 according to the invention can be used in an electric drive and load train 2, 3, in particular in an electric load train 2, for example, for a current generator, or in an electric drive train 3, for example, for an electric vehicle.

First of all, the electric load train 2 is to be described in more detail. In the load train 2 for a current generator, the electric machine 20, which is configured as a current generator machine, is connected to the motor inverter output of the motor inverter 300 and sends a generated alternating current to the motor inverter 300 and the controllable current source 100, which together operate as a frequency converter in order to feed a frequency-converted current into a mains supply 80. The current supply 80, in this case, is preferably a 3-phase high-voltage current supply.

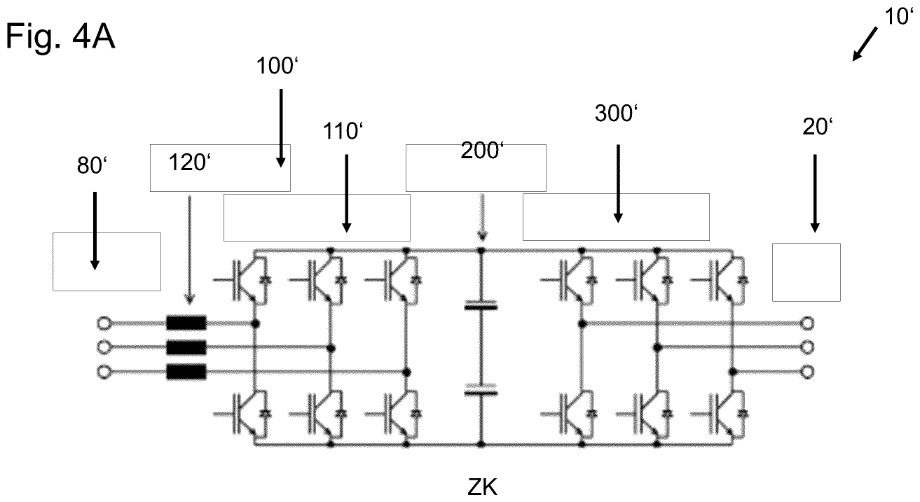

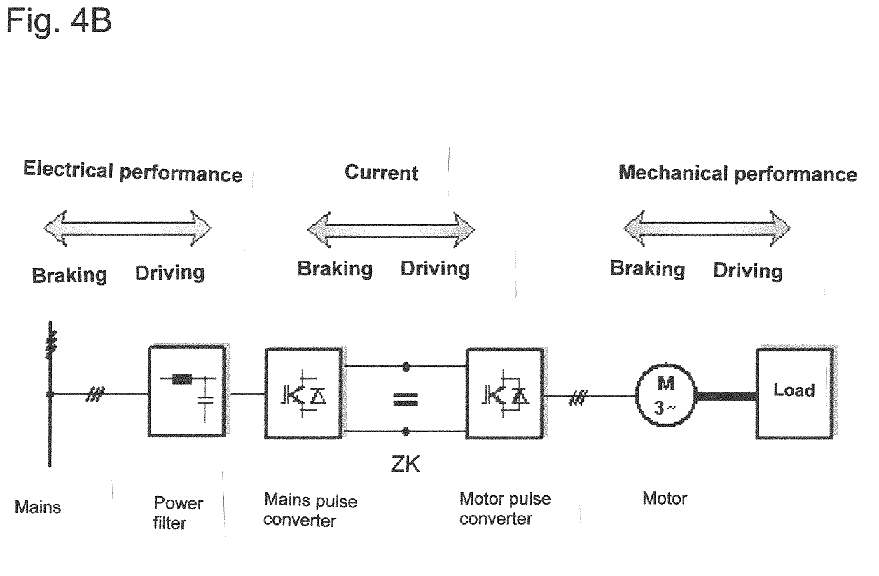

In the electric load train 2 for a current generator shown in FIG. 2, the controllable current source 100 is configured as an AC/DC converter similar to the motor or gearbox test stand 1 shown in FIGS. 1A and 1B, which comprises a frequency converter with a controlled mains rectifier, in particular an active front-end (AFE) converter with PID closed-loop control, in case of a 3-phase high-voltage current supply. Such an active front-end converter with PID closed-loop control will be discussed in more detail in the following text, in particular with reference to FIGS. 4A to 5B.

An important property of an AFE converter is that such a controllable current source 100 provides an electric drive current for the motor inverter 300 on one hand, but can also feed a direct current generated by the current generator 20 and converted by the motor inverter 300 into the mains 80 (see FIG. 4B). Since the drive and load system 10 according to the invention can drastically reduce both switching losses in the motor inverter 300 and magnetic losses in the current generator machine 20, an electric load train 2, in which the drive and load system 10 is used, is particularly effective and enables current generation with a high degree of efficiency.

The system shown in FIG. 2 can also be used as an electric drive train 3. In this case, the electric drive train can be used for any electrically operated mobile device such as an electric vehicle, an electric aircraft, an electrically operated drone, or an electrically operated ship. In this instance, the current supply 80 is configured as a mobile current supply, in particular as an accumulator module. The controllable current source 100, which is configured as a DC/DC converter for this purpose, is, in turn, connected to this accumulator module 80.

High-voltage DC/DC converters, which can ensure traction voltage stabilization in an electric drive train 3, are preferred in the electric drive train 3 for an electric car. For this purpose, so-called-non-insulating-DC/DC converters, which combine buck converters with boost converters into a buck-boost in such a manner that a bidirectional energy transfer from the accumulator module 80 to the electric motor 20 is made possible, as well as a feedback of current into the accumulator module 80. The described components of an electric drive train for an electric vehicle are well known to a person skilled in the art and are the subject of lectures (see, in this regard, lecture notes “Power electronics in a vehicle and drive train”, 2021/2022 winter semester, Prof. Dr.-Ing. Martin März, Chair of Power Electronics (LEE), Friedrich-Alexander University Erlangen-Nuremberg).

During drive, the electric machine 20 connected to the motor inverter output thus converts the drive current from the controllable current source 100 into rotational power, and, during braking operation, the electric machine 20 feeds the braking power back into the motor inverter 300, with the controllable current source 100, which is configured as a DC/DC converter, feeding the generated current, which has been converted into direct current by the motor inverter 300 and stored in the capacitor 200 (42 V-side intermediate circuit capacitor), back into the accumulator module 80, after the high-volt voltage has been reduced or converted accordingly, for example, to an operating voltage (14 V) of the traction battery 80. By using the drive and load system 10 according to the invention, which reduces switching losses in the motor inverter 300, the electric drive train 3 for an electric vehicle can operate particularly effectively, whereby the range of an electric vehicle, which includes this drive train 3, can be increased.

The mode of operation of the drive and load system 10 according to the invention in comparison with a conventional drive and load system will now be discussed in the following text.

FIG. 4A shows a conventional drive and load system 10′ for a rotating electric machine 20′ as an exemplary circuit configuration. Such a drive and load system 10′ is also designated as a frequency converter with a controlled mains rectifier. Such converters include active power switches 110′ at the input, which is designed there as a B6 bridge consisting of six power transistors, IGBTs or power MOSFETs. Although this requires more control effort, it nevertheless offers a number of advantages such as energy feedback into the mains if, for example, masses driven by the motor need to be braked. Furthermore, a pulse inverter enables an almost sinusoidal current consumption from the mains, which has significantly fewer low-frequency harmonics, as well as fast switching between motor and generator operation. On the mains side, the input-side clocking and possible resonance peaks can be sufficiently damped by special filters 120′. A PID closed-loop controlled AFE frequency converter is, for example, described in the paper “Dynamic Model of Active Front-End Converters with 2DOF-PI Controllers for DC Bus Voltage Control” by Anup Thapa et al., 2020 IEEE 21st Workshop on Control and Modeling for Power Electronics (COMPEL), Nov. 9-12, 2020, DOI: 10.1109/COM-PEL49091.2020.9265801.

The frequency converter 10′ shown in FIG. 4A consists of a mains-side pulse inverter 100′ (“active front end”) and a machine-side pulse inverter 300′ (“inverter”). The inverters 100′, 300′ convert mains voltage from the current supply 80′ that is constant in amplitude and frequency (50 or 60 Hz) into a system with variable voltage and frequency. Both power elements are equipped with IGBT (insulated gate bipolar transistor) switching elements 110′ or MOSFETs, in particular SiC MOSFETs. In general, all types of power semiconductor switching elements are covered by the invention as long as they can switch high currents reliably and quickly. This enables both motor and generator operation at full current.

FIG. 4B illustrates, in this case, the power flow in the system. The field-oriented vector closed-loop control of the machine-side frequency converter 300′ (corresponds to the motor inverter 300 according to the invention) enables excellent closed-loop control dynamics and very good concentricity over the entire speed range. The mains-side pulse inverter 100′ (corresponds to the controllable current source 100 according to the invention) is operated at a power factor cos φ=1. With this setting, no fundamental reactive power occurs. The mains currents are almost sinusoidal. The mains filter installed by default reduces the pulse-frequency harmonics to a minimum.

FIG. 5A shows a drive and load system 10′ for a rotating electric machine 20′ according to the prior art, which can be configured as a frequency converter with a controlled mains rectifier or as an AFE converter or active front-end converter, respectively, as shown in FIG. 4A. The aim of this drive and load system 10′ is to provide a defined supply voltage for the motor inverter 300′ directly at the supply input of the motor inverter 300′. In order to ensure that voltage drops are compensated for via the intermediate circuit ZK and the capacitor 200′ in case of high supply currents, a closed-loop control circuit 400′ is used in the frequency converter 100′ with a controlled mains rectifier, the actual value input of which is connected to the motor inverter input and which controls the motor inverter input voltage as an actual value to a setpoint U_{Set} in a closed-loop manner by means of the controllable current source 100′. A supply voltage is selected as the supply voltage U_{Zk} at the input of the motor inverter 300′ according to the prior art, which ensures sufficient power even at a high load and at maximum speeds.

This constant supply voltage U_{Zk} as an alternating voltage U_{Zk} [VAC] and as a direct voltage U_{Zk} [VDC] are shown as dashed lines in FIG. 5B and do not depend on the speed of the electric machine 20. In the example shown in FIG. 5B, this supply voltage U_{Zk} is set to 500 V. However, the required supply voltage Ukl of the electric machine 20′ or electric alternating current machine 20′ increases with increase of the speed to a maximum peak supply voltage and then remains constant. The intermediate circuit voltage or the DC bus voltage, which is applied to the input of the motor inverter 300′, is controlled in a closed-loop manner in accordance with the prior art independently of the speed so that a required supply voltage is provided for the electric machine 20 over the entire speed range and additional reserves are available for dynamic processes (especially for speeds above the peak supply voltage).

This can lead to unnecessarily high intermediate circuit voltages or DC bus voltages in a lower speed range, which are then accompanied by corresponding switching losses, as already described at the beginning. This applies, in particular, to permanent magnet (PM) machines, which are used in the high speed range and therefore require comparably low nominal voltages at the operating point of the nominal speed. Such a standard closed-loop control of an intermediate circuit voltage to a constant input voltage value U_{Zk} is shown in FIG. 5A. As can be seen from FIG. 5B, the supply voltage U_{Zk} provided in the low speed range is considerably higher than the supply voltage required in this speed range. However, in a motor inverter 300′ comprising a pulse inverter, this is associated with unnecessarily high switching losses at low speeds n, especially if this pulse inverter is equipped with power semiconductor switching elements such as IGBTs or MOSFETS, in particular SiC MOSFETs.

FIG. 6A now shows a drive and load system 10 according to an exemplary embodiment of the invention, which can be used for a rotating electric machine 20. In addition to the controllable current source 100, the intermediate circuit ZK with the capacitor 200, the motor inverter 300 and the closed-loop control circuit 400, the drive and load system 10 according to the invention also provides a setpoint output device 500, which is connected to the setpoint input of the closed-loop control circuit 400 and sets its current setpoint U_{Set} (t), wherein the setpoint output device is suitable for determining the current setpoint U_{Set} (t) for the closed-loop control circuit as a function of the speed n(t) of the electric machine by means of a predetermined setpoint curve U_{Set} [n(t)]. The aim of the setpoint curve U_{Set} [n(t)], in this case, is to come as close as possible to the course of the required supply voltage of the AC motor 20, with a specific safety margin, offset or voltage reserve being provided. As the voltage reserve is proportional to the charge stored in the capacitor 200, this voltage reserve also corresponds to an energy reserve for the electric machine 20.

In FIG. 6B, the setpoint curves U_{Set} (n) are again shown as an alternating voltage Uzk[VAC] and corresponding direct voltage Uzk[VDC] (corresponds to Uzk[VAC] *Sqrt [2]) is shown as dashed lines. Since the required supply voltage U_{Zk_min} or, equivalently in FIG. 6B, the required supply voltage or motor terminal voltage Uₖₗ is lower at low speeds of the alternating current machine 20 than at high speeds, it is advantageous in accordance with the invention if the setpoint curve U_{Set} (n) has a smaller setpoint voltage value at lower speeds than at high speeds. The setpoint curve U_{Set} (n) is therefore preferably increased in steps or gradually as the speed n increases. In accordance with the invention, the setpoint curve U_{Set} (n) can, in this case, have a constant saturation value U_{Max} (here U_{Max}=500 V) from a specific saturation speed nₛₐₜₜ (here at about 14,000 revolutions per minute). Furthermore, it is advantageous if there are specific voltage reserves for dynamic processes and the setpoint curve has a constant offset value U_{offset} as an addendum. This ensures that the setpoint voltage never falls below the required supply voltage.

The intermediate circuit voltage or DC bus voltage at the intermediate circuit ZK is thus calculated on the basis of the speed n and the speed gradient dn/dt. In order to maintain a certain lead voltage as a reserve during acceleration processes, the setpoint curve U_{Set} [n(t)] can have a positive lead component b*dn/dt as the addendum, which is dn/dt<0=0 in case of speed changes. The setpoint of the DC bus voltage or intermediate circuit voltage U_{Zk} is therefore only calculated based on the current speed n(t) if the speed gradient or the time derivative of the speed dn/dt is less than 0. The voltage setpoint U_{Zk} at the intermediate circuit ZK or the setpoint of the DC bus voltage is therefore only provided with a positive lead component if the time derivative of the speed is dn/dt>0. This leads to a lead control of the intermediate circuit voltage U_{Zk}, which is important for fast positive speed gradients dn/dt, as otherwise the DC bus voltage or intermediate circuit voltage cannot follow the voltage requirement of the machine quickly enough in case of high speed changes or accelerations and the electric machine 20 cannot be supplied with sufficient power.

As further shown in FIG. 6B, the setpoint curve U_{Set} [n(t)] can be divided into N consecutive speed intervals I1 to In. In the exemplary embodiment shown in FIG. 6B, the setpoint curve U_{Set} shows a first gradient in a first speed range up to about 4,000 revolutions per minute, then switches to a second speed range between 4,000 revolutions per minute and 14,000 revolutions per minute with a second gradient in order to then switch to a saturation value U_{Max} from 14,000 revolutions onwards. Furthermore, it is preferred if these corresponding gradients switch from high gradients to low gradients in the different intervals, as this is best adapted to the actual course of the required supply voltage. It is therefore expedient if the setpoint curve is divided into n consecutive speed intervals I1 to In and runs in the xth speed interval Ix with an associated linear gradient aₓ, wherein aₓ>aₓ₊₁>0 applies to the gradients.

Although only two speed intervals (from 0 to 4,000 revolutions per minute and from 4,000 revolutions per minute to 14,000 revolutions per minute) with two different gradients are shown in FIG. 6B, the number N of speed intervals can also consist of 10 intervals or even 100 intervals. However, in order to keep closed-loop control simple, it is preferred if N is less than 1000, or less than 500, or less than 200, or less than 100, or less than 90, or less than 80, or less than 70, or less than 60, or less than 50, or less than 40, or less than 30, or less than 20, or less than 10, or less than 9, or less than 8, or less than 7, or less than 6, or less than 5, or less than 4, or less than 3, or equal to 2, or equal to 1.

In this case, it is expedient if the following applies to the setpoint curve U_{Set} [n(t)] in the xth speed interval Iₓ of N consecutive speed intervals I₁ to I_{N}:

$${U}_{Set \_ x} [ n ( t ) ] = {a}_{x}^{*} n ( t ) + {b}_{x}^{*} dn / dt + {U}_{Offset} + {U}_{Delta \_ x} , for {n}_{x - 1} \leq n < {n}_{x}$$

wherein the following applies:

$${n}_{0} = 0 ;$$

aₓ is a gradient factor with a₀=0 and aₓ>0;
dn/dt is the time derivative of the speed n(t),
bₓ is a lead factor with bₓ=0 at dn/dt<0,
U_{Offset} is an offset value,
U_{Delta_x} is a continuity value with

$${U}_{Delta \_ x} = {\sum }_{i = 1}^{x} {a}_{i - 1} ( {n}_{i} - {n}_{i - 1} ) .$$

The following applies in addition:

$${U}_{Set \_ x} [ n ( t ) ] = {U}_{Max} for n ( t ) > {n}_{N} = {n}_{s a t} .$$

However, it is also possible to approximate (fit) the setpoint curve U_{Set} [n(t)] as a root function of the required supply voltage and provide it with an offset value:

$${U}_{S e t} [ n ( t ) ] = {c}^{⋆} \sqrt{d * n ( t )} + {U}_{offset}$$

In addition, the lead component b*dn/dt can also be included:

$${U}_{S e t} [ n ( t ) ] = {c}^{⋆} \sqrt{d * n ( t )} + {b}^{*} dn / dt + {U}_{Offset}$$

Other functions such as a logarithmic function are also conceivable in order to adjust the setpoint curve U_{Set} [n(t)] as precisely as possible to the course of the required supply voltage as a function of the speed, so that the same voltage reserve U_{Offset}+b*dn/dt is available at any speed:

$${U}_{S e t} [ n ( t ) ] = {e}^{⋆} log [ {f}^{*} n ( t ) \hat{} g + 1 ] + {b}^{*} dn / dt + {U}_{Offset}$$

The gradient factor a lies, in this case, expediently in a range from 0.001 V/rpm to 1 V/rpm, or from 0.005 V/rpm to 0.5 V/rpm, or from 0.01 V/rpm to 1 V/rpm. The offset value U_{Offset} lies, in this case, expediently in a range from 1 V to 1000 V, or from 5 V to 500 V, or from 10 V to 200 V, or from 10 V to 100 V. The lead factor b lies expediently in a range from 1 V*s/rpm to 10 MV*s/rpm, or from 10 V*s/rpm to 1 MV*s/rpm, or from 100 V*s/rpm to 100 kV*s/rpm. The parameter c lies expediently in a range from 0.1 V to 100 V, or from 0.5 V to 50 V, or from 1 V to 10 V. The parameter d lies expediently in a range from 0.1 min/revolution to 100 min/revolution, or from 0.5 min/revolution to 50 min/revolution, or from 1 min/revolution to 10 min/revolution. The parameter e lies expediently in a range from 0.1 V to 100 V, or from 0.5 V to 50 V, or from 1 V to 10 V. The parameter f lies expediently in a range from 0.1 min/revolution to 100 min/revolution, or from 0.5 min/revolution to 50 min/revolution, or from 1 min/revolution to 10 min/revolution. The parameter g lies expediently in a range from 0.1 to 100, or from 0.5 to 50, or from 1 to 10. The voltage values given in volt are, in this case, related to the alternating voltage values Uzk[VAC], as shown in FIGS. 5B and 6B.

In case that the required supply voltage can either be measured or simulated as a function of the speed, the setpoint curve U_{Set} (n) can also comprise a sum formed from a minimal supply voltage curve U_{Zk}_min (n) of the motor inverter 300 and the electric machine 20, as well as an offset value U_{Offset}. In this case, the required supply voltage curve U_{Zk_min} (n) can be an interpolated function of data points from measured required supply voltages and associated speeds n. The interpolating function can, in this case, be one of the functions described above, which is fitted to the data set accordingly. Furthermore, the setpoint curve U_{Zk_Set} (n) can have at least one speed interval Iₓ between the speed 0 and the speed n_{Sat}, in which the setpoint curve has a step-like increasing, a continuously increasing, a linearly increasing, a root-shaped increasing or a logarithmically increasing component. The setpoint curve can be any monotonically increasing function. The setpoint curve can be any constant and monotonically increasing function.

In addition to controlling the voltage in a closed-loop manner as a function of the speed, it is also provided in accordance with the invention that the setpoint output device 500 is further suitable for determining a current setpoint U_{Set} (t) for the closed-loop control circuit as a function of the torque M(t) of the electric machine 20 by means of a predetermined setpoint curve U_{Set} [n(t), M(t)]. It is not possible to control the intermediate circuit voltage in a closed-loop manner as a function of the torque M(t) only. However, in accordance with the invention, it is expedient if, in addition to the evaluation of the speed n(t), the torque M(t) is used as a further influencing variable on the setpoint U_{Set} [n(t), M(t)] of the intermediate circuit voltage.

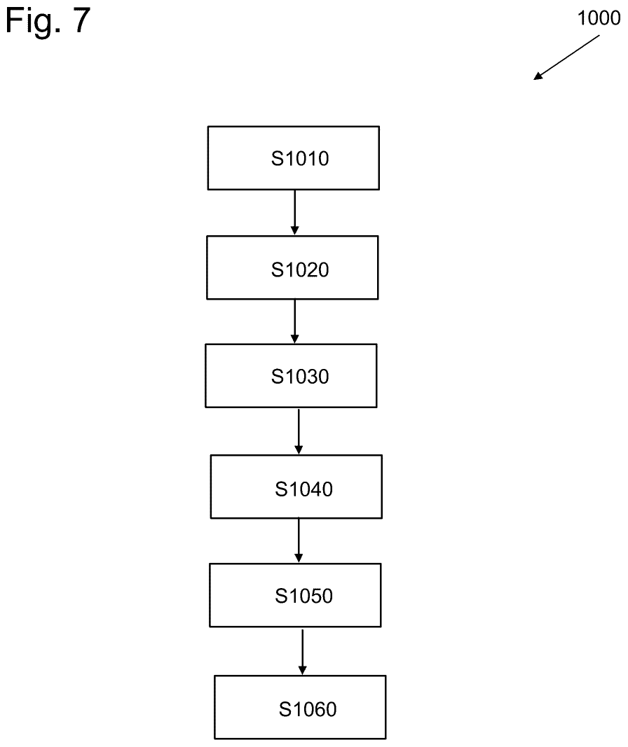

FIG. 7 depicts a flow chart of a method for operating a drive and load system 10 for a rotating electric machine 20. Thus, the method 1000 comprises a first step S1010 of providing a controllable current source 100 that can be connected to a current supply. In a further step S1020, an intermediate circuit ZK connected to the controllable current source 100 is provided, which has a capacitor 200 for the intermediate storage of current. In a further step S1030, a motor inverter 300 connected to the intermediate circuit ZK is provided, which converts the intermediate circuit voltage applied to the motor inverter input into a drive current for a rotating electric machine 20 or feeds a load current from the electric machine 20 back into the intermediate circuit ZK. In a further step S1040, a closed-loop control circuit 400 is provided the actual value input of which is connected to the motor inverter input and which controls the motor inverter input voltage as an actual value to a setpoint U_{Set} in a closed-loop manner by means of the controllable current source 100. In a still further step S1050, a setpoint output device 500 is provided, which is connected to the setpoint input of the closed-loop control circuit and sets its current setpoint U_{Set} (t). In a step S1060, the current setpoint U_{Set} (t) for the closed-loop control circuit 400 is determined, as described above, as a function of the speed n(t) of the electric machine by means of a predetermined setpoint curve U_{Set} [n(t)].

The control or closed-loop control of the DC bus voltage or intermediate circuit voltage, depending on the speed and the speed gradient, leads to a reduction in losses, in particular switching losses and magnetic losses, which occur in the motor inverter 300 and the electric machine 20. These magnetization losses occur in the machine and in a possibly installed choke (on the mains side and on the motor side), where the magnetization losses of the motor-side chokes can also be reduced.

This applies, in particular, to high-speed PM synchronous motors. Thus, during operation in a test stand, the thermal load can be reduced at low speeds and full load, since only a low supply voltage, which corresponds to the supply voltage actually required, is applied to the input of the motor inverter 300 at the operating point. In accordance with the invention, a DC bus voltage of a drive system is therefore, based on the machine speed and the speed gradient, controlled in a closed-loop manner in such a way that switching losses at low speeds are compensated for by applying a lower voltage. Thus, magnetic losses in the AC machine and possibly in installed motor chokes and switching losses in the IGBT switching elements, or SIC MOSFETSs, or generally power semiconductor switching elements, or power transistors of the drive system can be reduced, and the efficiency of the drive and load system 10 according to the invention can be increased.

1-15. (canceled)

16. A drive and load system for a rotating electric machine, the drive and load system comprising:
a controllable current source configured to be connected to a current supply;
an intermediate circuit connected to the controllable current source and comprising a capacitor configured for an intermediate storage of current;
a motor inverter connected to the intermediate circuit and configured to convert an intermediate circuit voltage applied to a motor inverter input into a drive current for the rotating electric machine, or to feed a load current from the rotating electric machine back into the intermediate circuit;
a closed-loop control circuit having an actual value input connected to the motor inverter input, and configured to control the motor inverter input voltage as an actual value to a setpoint U_{Set} (t) in a closed-loop manner via the controllable current source;
a setpoint output device connected to a setpoint input of the closed-loop control circuit and configured to set the setpoint U_{Set} (t),
wherein the setpoint output device is further configured to determine the current setpoint U_{Set} (t) for the closed-loop control circuit as a function of the speed n(t) of the electric machine via a predetermined setpoint curve U_{Set} [n(t)].

17. The drive and load system of claim 16, wherein the setpoint curve U_{Set} [n(t)] is increased in steps or gradually with increasing speed n.

18. The drive and load system of claim 16, wherein the setpoint curve U_{Set} [n(t)] has a constant saturation value U_{Max} from a saturation speed n_{Sat}.

19. The drive and load system of claim 16, wherein the setpoint curve U_{Set} [n(t)] has a constant offset value U_{Offset} as an addend.

20. The drive and load system of claim 16, wherein the setpoint curve U_{Set} [n(t)] has a positive lead component b*dn/dt as the addend, which is equal to 0 in case of speed changes dn/dt<0.

21. The drive and load system of claim 16, wherein the setpoint curve U_{Set} [n(t)] is divided into N consecutive speed intervals I₁ to I_{N} and runs in the xth speed interval Iₓ with an associated linear gradient aₓ, and wherein aₓ>a_{x+1>0} applies to the gradients.

22. The drive and load system of claim 16, wherein the following applies to the setpoint curve U_{Set} [n(t)] in the xth speed interval lₓ of N consecutive speed intervals I₁ to I_{N}: U_{Set_x} [n(t)]=aₓ*n(t)+bₓ*dn/dt+U_{Offset}+U_{Delta_x}, for nₓ₋₁≤n<nₓ,
wherein n₀=0; aₓ is a gradient factor with a₀=0 and aₓ>0; dn/dt is the time derivative of the speed n(t), bₓ is a lead factor with bₓ=0 at dn/dt<0, U_{Offset} is an offset value, U_{Delta_x} is a continuity value with
$${U}_{Delta \_ x} = {\sum }_{i = 1}^{x} {a}_{i - 1} ( {n}_{i} - {n}_{i - 1} ) ,$$
and
wherein the following additionally applies: U_{Set_x} [n(t)]=U_{Max} for n(t)>n_{N}=n_{Sat}.

23. The drive and load system of claim 16, wherein the setpoint curve U_{Set} (n) comprises a sum formed from a required supply voltage curve U_{Zk_min} (n) of the motor inverter and the rotating electric machine, as well as an offset value U_{Offset}.

24. The drive and load system of claim 23, wherein the required supply voltage curve U_{Zk_min} (n) is an interpolated function of data points from measured required supply voltages and associated speeds n.

25. The drive and load system of claim 16, wherein the setpoint output device is further configured to determine a current setpoint U_{Set} (t) for the closed-loop control circuit as a function of the torque M(t) of the electric machine (20) via a predetermined setpoint curve U_{Set} [n(t), M(t)].

26. The drive and load system of claim 16, wherein the motor inverter comprises a pulse inverter equipped with a plurality of power semiconductor switching elements.

27. The drive and load system of claim 26, wherein the power semiconductor switching elements are IGBTs or MOSFETSs.

28. The drive and load system of claim 16, wherein the controllable current source comprises a frequency converter with a controlled mains rectifier.

29. The drive and load system of claim 28, wherein the frequency converter with the controlled mains rectifier includes an active front-end (AFE) converter with PID closed-loop control.

30. A test stand, comprising:
the drive and load system of claim 16;
an electric machine connected to the motor inverter and configured to drive or load a test specimen designed as an electric motor or internal combustion engine;
a mechanical shaft connection configured to connect shafts of the electric machine and the test specimen;
an evaluation unit;
a torque measuring unit configured to measure torque via a torque measuring flange on the mechanical shaft connection and transmit the measured torque to the evaluation unit; and
a speed recording unit configured to measure the speed n(t) via a pulse generator on the mechanical shaft connection and transmit the measured speed n(t) to the evaluation unit,
wherein the evaluation unit is configured to receive the measured torque M(t) and the measured speed n(t), and store the measured torque M(t) and the measured speed n(t).

31. An electric load train, comprising:
the drive and load system of claim 16;
the electric machine connected to the motor inverter output, which is configured as a current generator to send a generated alternating current to the motor inverter, as well as the controllable current source as a frequency converter to feed a frequency-converted current into a mains supply.

32. An electric drive train, comprising:
a mobile current supply;
the drive and load system of claim 16;
the electric machine connected to the motor inverter output, which is configured to convert the drive current into rotational power and feed braking power back into the motor inverter,
wherein the controllable current source is configured as a DC/DC converter.
